(19) United States
(12) Patent Application Publication
(10) Pub. No.: US 2017/0314580 A1
(43) Pub. Date: Nov. 2, 2017

(54) INTERFACE RESISTANTVALVE ASSEMBLIES AND METHODS FOR SAME

(71) Applicant: Raven Industries, Inc., Sioux Falls, SD (US)

(72) Inventors: Seth Steensma, Sioux Falls, SD (US); Brent A. Driesen, Alvord, IA (US)

(21) Appl. No.: 15/585,034

(22) Filed: May 2, 2017

Related U.S. Application Data
(60) Provisional application No. 62/330,707, filed on May 2, 2016.
(60) Provisional application No. 62/332,876, filed on May 6, 2016.

(51) Int. Cl. F15B 13/04; F02M 59/46; F16K 31/06

(52) U.S. Cl. CPC F15B 13/0405; F02M 59/466; F16K 31/0655

(57) ABSTRACT

A valve assembly includes a valve body having a fluid inlet and a fluid outlet. An operator cavity is within the valve body, and the valve body includes a valve operator socket surface. A valve operator is slidably coupled with the valve body and in the operator cavity. The valve operator includes an operator surface configured to selectively isolate the fluid inlet from the fluid outlet, and an end surface. At least one of the valve operator socket surface or the end surface of the valve operator include a discontinuous interface. The discontinuous interface includes a recessed surface, and one or more interface breaking projections extending from the recessed surface, the one or more interface breaking projections space the recessed surface from the valve operator socket surface.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux S. Dak. All Rights Reserved.

### TECHNICAL FIELD

This document pertains generally, but not by way of limitation, to valves including poppet valves.

### BACKGROUND

Poppet valves use a solenoid to move a valve operator between the closed and open positions. A pressurized fluid is delivered through the poppet valve according to the application of current to a solenoid coil. In one example, the application of current generates a magnetic field to move the valve operator to the open position and allow the pressurized fluid to flow through the valve for instance to a nozzle. The arresting of current de-energizes the solenoid coil and a biasing element, such as a spring, biases the valve operator to the closed position.

### OVERVIEW

The present inventors have recognized, among other things, that a problem to be solved can include decreasing (e.g., minimizing or eliminating) vacuum or adhesion seizing of a valve operator caused by fluids conveyed through the valve. In some examples, the conveyed fluid provides an adhesive interface between the valve operator and the valve operator socket surface of a valve body. When the valve operator is in an elevated position and away from the fluid inlet and outlet at least an end surface of the valve operator is seated along the valve operator socket surface. One or more of a vacuum or adhesive interface is generated at the interface between these surfaces that seizes the valve operator and decreases the responsiveness of the valve (and correspondingly the precision of dispensing). In some examples, high viscosity or particulate enriched fluids, such as water and non-water based liquid fertilizers adhere the surfaces together or slow the movement of the fluid and generate a vacuum (negative pressure) as the valve operator is biased away from the valve operator socket surface. The biasing element (optionally a spring, counter current or voltage or the like) fails to generate sufficient force in the valve operator to overcome the adhesion or vacuum and the valve operator is seized in the elevated position (e.g., an open position). In examples with the valve operated according to an oscillating duty cycle (with the valve operator cyclically moved between open and closed positions to adjust one or more of the flow rate or the pressure of the dispensed fluid) seizing of the valve operator frustrates operation of the valve at the desired flow rate or dispensing pressure. For instance, if a duty cycle is 10 hz or 600 milliseconds and an operation of 10 percent open and 90 percent closed is desired (e.g., high pressure for broad coverage) seizing of the valve operator frustrates the precise operation of the valve (may skip or alter the length of closed positions because of seizing) and accordingly frustrates precise dispensing of the conveyed fluid such as an agricultural product at the rate and pressure desired.

The present subject matter can help provide a solution to this problem, such as by providimg a poppet valve assembly including one or more of an end surface of a valve operator or valve operator socket surface that includes a discontinuous surface having a recessed surface and one or more vacuum breaking projections extending from the recessed surface. The recessed surface spaces the valve operator socket surface from at least the end surface of the valve operator according to the projections. The pressurized conveyed fluid (e.g., 100 psi) infiltrates the space between the socket surface and the end surface and accordingly aborts an adhesion or vacuum interface otherwise present therebetween. The valve operator, without being subject to vacuum or adhesion, thereby readily moves from the open position (e.g., at an end of the operator cavity) to the closed position with release of the valve operator, for instance by arresting or application of current to a solenoid coil. Further, the pressurized conveyed fluid distributed along the recessed surface in another example assists in biasing of the valve operator toward the closed position (according to the pressure of the fluid). Stated another way, the valve assembly described herein aborts a potential vacuum or adhesion interface between the valve body and the valve operator and at the same time enhances the operation (e.g., oscillating duty cycle) of the valve operator to ensure precise operation of the valve assembly and corresponding precise delivery of a conveyed fluid according to a specified parameter, for instance one or more of a desired flow rate or pressure.

This overview is intended to provide an overview of subject matter of the present patent application. It is not intended to provide an exclusive or exhaustive explanation of the disclosure. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of an agricultural sprayer.

FIG. 2A is a schematic view of another example of an agricultural sprayer.

FIG. 2B is a schematic view of one example of a sprayer row unit including an interface resistant valve assembly.

FIG. 3 is a perspective view of the sprayer row unit of FIG. 2B.

FIG. 4A is a perspective view of the interface resistant valve assembly of FIG. 2B.

FIG. 4B is a cross sectional view of the interface resistant valve assembly of

FIG. 4A.

FIG. 4C is an exploded view of the interface resistant valve assembly of FIG. 4A.

FIG. 4D is a perspective view of one example of a valve operator.

FIG. 5A is a cross sectional view of another example of an interface resistant valve assembly.

FIG. 5B is an exploded view of the interface resistant valve assembly of FIG. 5A.

FIG. 6A is a schematic view of an additional example of an agricultural sprayer.

FIG. 6B is a schematic view of an additional example of a sprayer row unit including the interface resistant valve assembly.

FIG. 7A is a schematic view of a further example of an agricultural sprayer.

FIG. 7B is a schematic view of a further example of a sprayer row unit including the interface resistant valve assembly. FIG. 8 is a block diagram showing one example of a method for using an interface resistant valve assembly.

### DETAILED DESCRIPTION

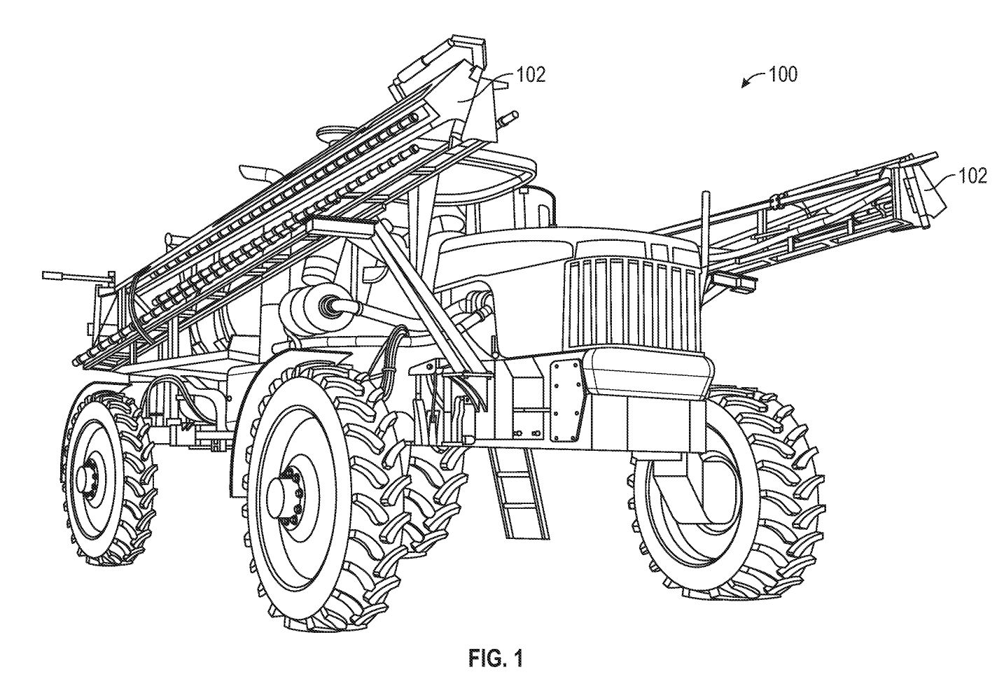

FIG. 1 shows one example of a sprayer 100. As shown, sprayer 100 is a vehicle based sprayer including an agricultural product dispensing system carried by the vehicle. In another example, the sprayer 100 includes, but is not limited to, a trailer housed sprayer configured for coupling with a vehicle, such as a tractor or the like. As shown in FIG. 1, the sprayer 100 includes at least two sprayer booms 102. The sprayer booms 102 shown in FIG. 1 are in a stowed configuration, for instance during transport of the sprayer 100 into a field. The sprayer is configured to apply one or more agricultural products including, but not limited to, fertilizers, herbicides, pesticides or the like. The sprayer 100 applies the agricultural product in a liquid form, for instance through one or more nozzle assemblies positioned along the sprayer boom 102 according to the spacing of rows of agricultural crops. As will he described herein, the sprayer 100 applies the agricultural product by mixing an injection product with a carrier fluid to achieve a desired concentration of the injection product (a fertilizer, herbicide, pesticide or the like) within the carrier fluid. In another example, the injection product includes a plurality of injection products, for instance injected separately by way of differing injection systems or injected as a common mixture of fluids (e.g., from a mixed injection reservoir) into the product dispensers including one or more of the boom sections and nozzle assemblies of the sprayer booms 102.

As will be described herein, an agricultural product is optionally provided in a localized manner to each of the product dispensers whether boom sections or nozzles to provide individualized control of application of the agricultural product. In other examples, the injection product is added to a carrier fluid to form the agricultural product locally relative to the product dispensers (boom sections, nozzle assemblies or the like) immediately prior to dispensing to ensure lag time between a desired change in concentration of the injection product and the corresponding application of the adjusted agricultural product is minimized (e.g., there is negligible lag time or near instant injection and dispensing of the resulting agricultural product at a specified concentration). In contrast to local injection and mixing, other systems (also described herein) mix the injection product upstream from the product dispensers, for instance within the carrier fluid reservoir or at an interchange near a header pump for the carrier fluid.

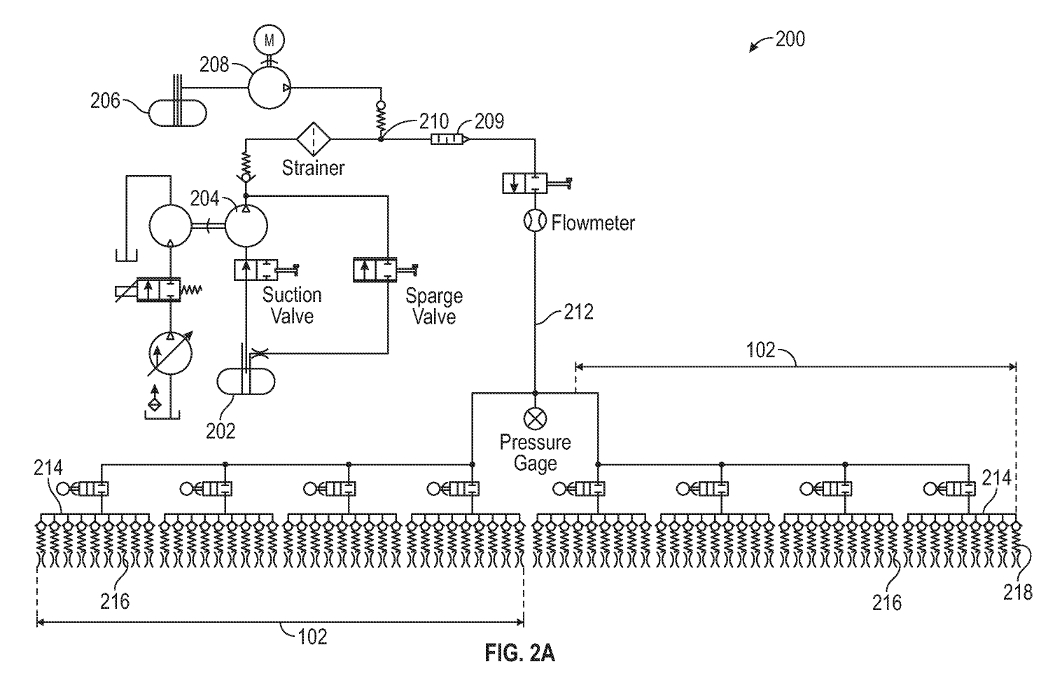

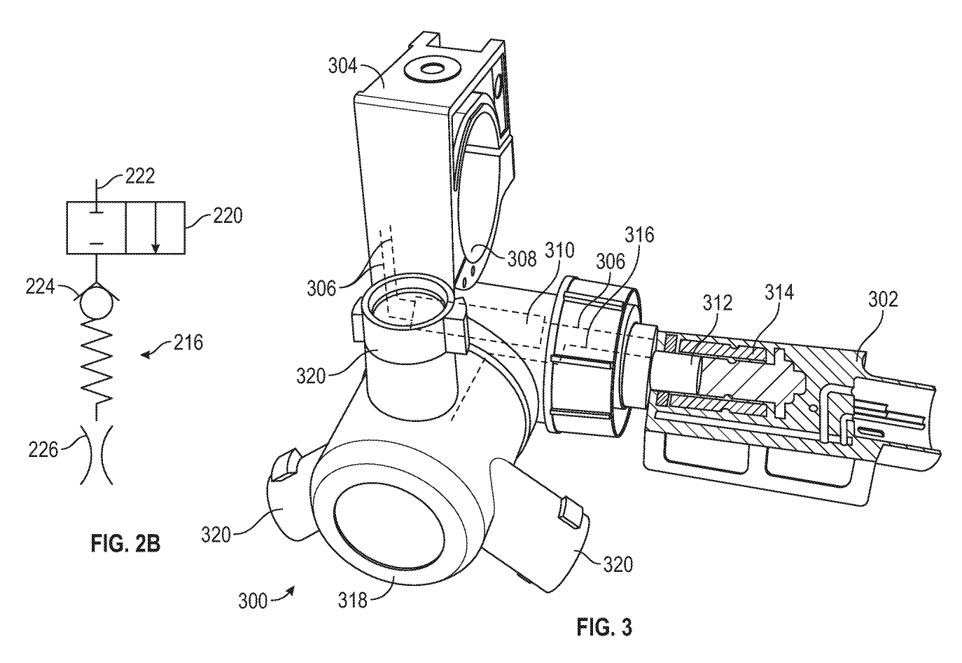

FIG. 2A shows another example of a sprayer 200. The sprayer 200 shown in FIG. 2A includes a consolidated system having the product injection reservoir 206 and the injection pump 208 feeding into an injection port 210 of a header 212 of the sprayer 200. For instance, the carrier fluid is pumped from a carrier reservoir 202 by a carrier pump 204 and supplemented with the injection product at the injection port 210 (e.g., by the injection pump 208). In one example, a mixer 209 is provided downstream from the injection port 210 for mixing the injection product with the carrier fluid prior to delivery through the header 212 to the sprayer booms 102 including one or more of boom sections 214, nozzle assemblies 216 or the like.

As further shown in FIG. 2A, the injection product is provided to the flow of carrier fluid upstream from the nozzle assemblies 216 and the boom sections 214. Each of the nozzle assemblies 216 and the boom sections 214 (the product dispensers 218) delivers the same concentration of the injection product (relative to the carrier fluid) within the agricultural product across the sprayer 200.

FIG. 2B shows a detailed schematic view of one example of a nozzle assembly 216 (an example product dispenser). The nozzle assembly 216 is included, in one example, with the sprayer 200 as one nozzle assembly of a plurality of assemblies 216 included in each boom section 214. In another example, the nozzle assembly 216 is a separate component independent of other nozzle assemblies used in a sprayer (e.g., each nozzle assembly 216 is operated independently and not part of an overall boom section).

Referring again to FIG. 2B, the nozzle assembly 216 includes an inlet 222 at one end of the assembly and a dispensing nozzle 226 at the other end. A valve assembly 220 is interposed between the inlet 222 and the dispensing nozzle 226. As will be described herein, the valve assembly 220 controls the flow of fluid (e.g., a carrier fluid and injection product, or separated carrier fluid or injection product or the like) through the valve and correspondingly through the dispenser nozzle 226.

In one example, the valve assembly 220 includes an operating mechanism, such as a solenoid, configured to move a valve operator (described herein) between open and closed positions. Optionally, the solenoid is operated in an oscillating manner to open and close the valve at one or more duty cycles and accordingly deliver fluid through the valve assembly at a flow rate corresponding to the duty cycle. As an example, if a duty cycle is 10 hz or 600 milliseconds this corresponds to the valve assembly oscillating open 10 percent of the 600 milliseconds and oscillating closed 90 percent of the 600 millisecond period (e.g., for a high pressure and broad coverage). Conversely with a higher duty cycle of 50 hz or more the valve assembly is open more than 10 percent and closed less than the 90 percent over a time period compared to the lower duty cycle.

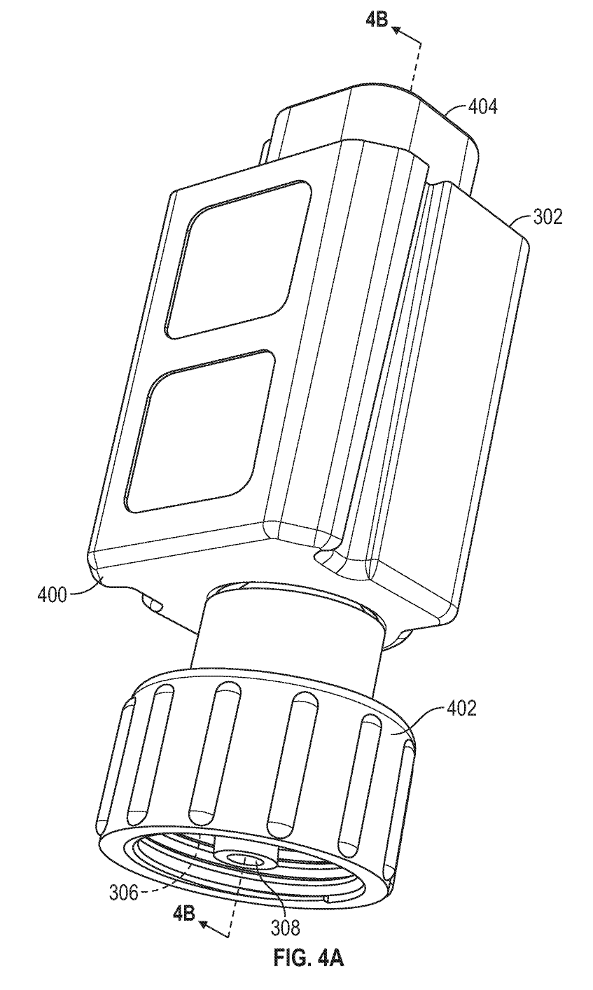

FIG. 3 shows another example of a valve assembly 302. As shown, the valve assembly 302 is coupled with an overall nozzle assembly 300. In this example, the nozzle assembly 300 includes an interface clamp 304 configured for coupling with one or more features, for instance, a boom tube or boom section of an overall sprayer. As further shown in FIG. 3, the nozzle assembly 300 includes an example nozzle body 318. In this example the nozzle body 318 includes a plurality of nozzles provided on a rotatable fixture coupled with the remainder of the nozzle assembly 300.

Referring again to FIG. 3, the interface clamp 304 is, in one example, configured for coupling around a tube such as a boom tube or boom section of a sprayer, such as the square 100 shown, for instance, in FIG. 1. The interface clamp 304 includes an input face 308 (e.g., on the interior surface of the clamp) including one or more ports configured to couple with corresponding ports on a boom tube or boom section. The ports of the input face 308 supply an agricultural product (e.g., a carrier fluid, an injectant product mixed with a carrier fluid, separate flows of carrier fluid and an injectant product or the like) through the interface clamp 304 to the valve assembly 302. In the example shown in FIG. 3, two valve inputs 306, shown in broken lines and interior to the interface clamp 304, extend from the input face 308 to a mixing chamber 310. In this example, with the mixing chamber 310, one of the value inputs 306 carries a carrier fluid and another of the valve inputs 306 carries an injectant product. At the mixing chamber 310, the carrier fluid and the injectant product are mixed together, for instance, by one or more of vanes, circuitous passages or layers through the mixing chamber 310, and then administered through the valve input 306 extending between the mixing chamber 310 and the valve assembly 302. In other examples, a plurality of valve inputs 306, for instance, two or more valve inputs 306, extend from the input face 308 and are configured to provide various injectant products and the carrier fluid (e.g., in different quantities) prior to administration through the valve assembly 302. In still other examples, and as previously described herein, in one example, the valve assembly 302 supplies a flow of agricultural product, for instance, a premixed fluid having the carrier fluid and an injectant product therein provided at a specified concentration, for instance, by way of upstream mixing at the mixer 209 shown in FIG. 2A. In this example, a single valve input 306 extends from the interface clamp 304 to the valve assembly 302 to facilitate the dispensing of the agricultural product through the nozzle assembly 300.

As further shown in FIG. 3, the valve assembly 302 is, in one example, coupled with the interface clamp 304, for instance, with one or more of a valve clamp, threaded valve ring or the like of the valve assembly coupled with a portion of the interface clamp 304. The valve assembly 302, in a manner similar to the valve assembly 220 shown in FIG. 213, is interposed between the valve input 306 and the one or more nozzles 320.

As further shown in FIG. 3, in this example, the valve assembly 302 includes a solenoid 314 configured to actuate a valve operator 312 translationally to control communication between the valve input 306 and the valve output 316. As previously described herein, in one example, the solenoid 314 operates the valve operator 312 in an oscillating manner, for instance, according to one or more duty cycles, provided through a data port, wireless communication transceiver or the like to the valve assembly 302. By moving the valve operator 312 in an oscillating manner (e.g., at one or more frequencies) the flow rate through the valve assembly 302, and accordingly through the nozzle assembly 300, is thereby controlled. The agricultural product is thereafter distributed through the valve output 316 to the nozzle body 318. In the example shown in FIG. 3, the valve operator 312 is a poppet valve operator.

The nozzle body 318, in the example shown in FIG. 3, includes a plurality of dispensing nozzles arranged around a central portion of the nozzle body 318. In one example, the nozzle assembly 300, including the plurality of nozzles on the nozzle body 318, is configured to provide a variety of spray patterns, for instance, for one or more of fertilizer, pesticides or the like to agricultural crops. Accordingly, where a user desires to administer a fertilizer, the nozzle body 318 is rotated to position the appropriate nozzle 320 in a operative position (in communication with the valve output 316) to accordingly spray agricultural crops with a fertilizer. In other examples, for instance, with spraying of a pesticide, herbicide or the like, the nozzle body 318 is correspondingly rotated to the appropriate nozzle 320 to dispense the herbicide or pesticide with the corresponding spray patterns.

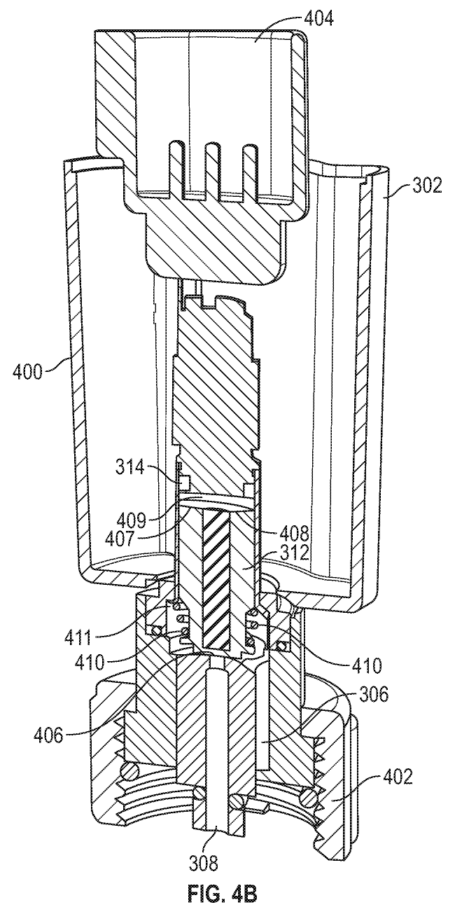

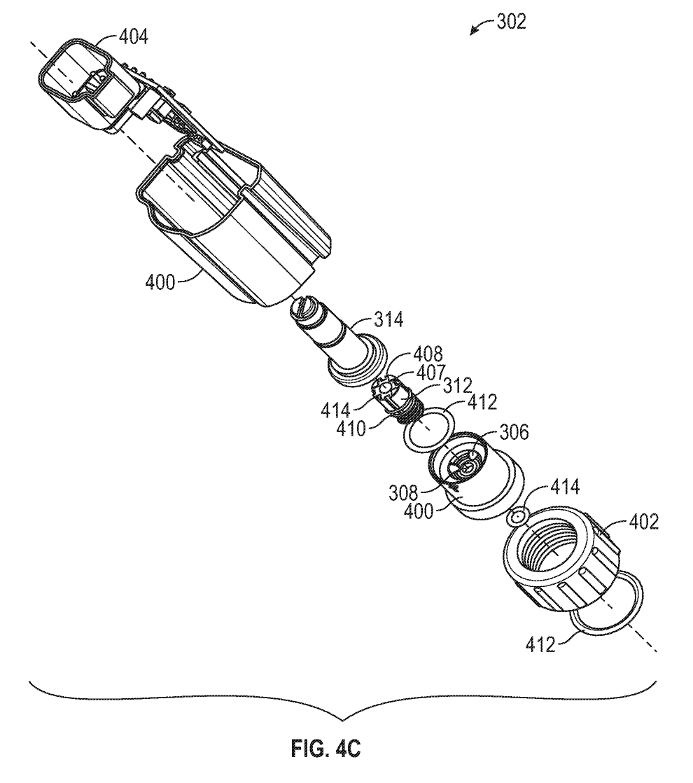

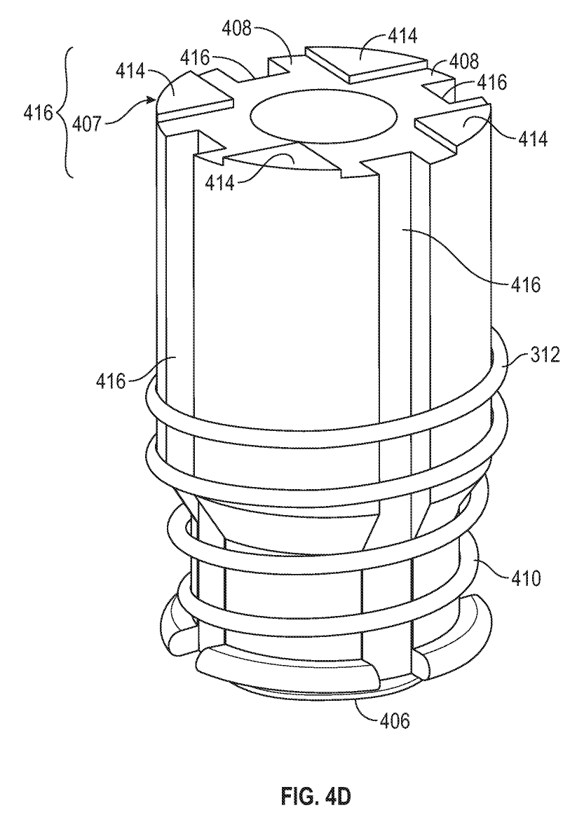

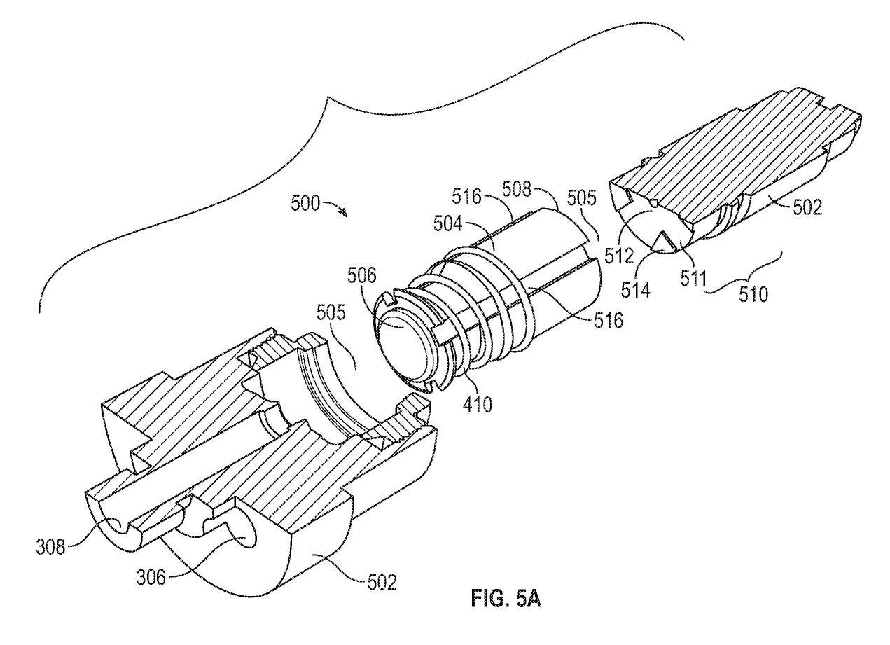

Referring now to FIGS. 4A, 4B and 4C, the valve assembly 302 previously shown in FIG. 3 is shown in detail. Referring first to FIG. 4A, the valve assembly 302 is shown in a decoupled configuration relative to the nozzle assembly 300 shown in FIG. 3. The valve assembly 302 includes a valve body 400 housing the components of the valve therein. A valve coupler 402 is, in one example, rotatably coupled with the valve body 400. In the example shown in FIG. 4A, the valve coupler 402 includes a rotatable ring having threading matching corresponding threading on one or more features of the nozzle assembly 300. In the example shown in FIG. 3, the nozzle assembly 300 includes an interface clamp 304 having a threaded interface configured for coupling with the valve assembly 302 with the valve coupler 402. As further shown in FIG. 4A, the valve input 306 (having a broken lead line and within the valve coupler 402) and the valve output 308 extend through the valve coupler 402 into the remainder of the valve body 400. As further shown in FIG. 4A, a power and data port 404 is, in one example, provided with the valve assembly 302 to facilitate the transfer of power and data to and from the valve assembly 302. The power and data port 404 transmits one or more of power for actuation of the valve (e.g., with a solenoid, air or a pneumatically controlled valve or the like) and data to provide instruction signals to the valve assembly 302 and, where applicable, to transmit information to a controller.

Referring now to FIG. 4B, the valve assembly 302 is shown in a sectional view. The valve assembly 302 includes the valve operator 312 moveably positioned within an operator cavity 411 of the valve body 400. In the example shown, the valve operator 312 includes a biasing element 410, such as a coil spring, configured to bias the valve operator 312 into a closed position, for instance, with the operator surface 406 engaged along surfaces corresponding to one or more of the valve input 306 and valve output 308 within the valve body 400. An end surface 407 of the valve operator 312 engages with a valve operator socket surface 409 in another portion of the valve cavity 411, for instance adjacent to a portion of the valve body including the solenoid 314.

Although the valve assembly 302 includes a solenoid 314 as shown other valve actuators are optionally included with the valve assembly 302 and are configured to move the valve operator 312 and accordingly open the one or more valve inputs 306 to the valve output 308. Other valve actuators include, but are not limited to, pneumatic, hydraulic actuators or the like.

As further shown in FIG. 4B, the power and data port 404 provides one or more pins, contacts, pneumatic ports or the like configured to provide power and data for instance to one or more control systems such as a circuit board, pneumatic interface or the like coupled with the valve actuator, such as the solenoid 314. By transmitting power and data (corresponding to instructions and sensed characteristics at the valve or in a sprayer) to the solenoid 314, the valve operator 312 is, in one example, operated at a variety of frequencies or duty cycles to accordingly regulate (e.g., control, vary, adjust, change or the like) the flow of an agricultural product through the valve assembly 302 from the valve inputs 306 to the valve output 308.

FIG. 4C shows an exploded view of the example valve assembly 302 previously shown in FIGS. 3, 4A and 4B. In this example, the valve body 400 is split into two separate components with the solenoid 314, valve operator 312 and a gasket 412 interposed therebetween. As further shown in FIG. 4C, the power and data port 404 is shown in a decoupled view relative to the valve body 400. The power and data port 404 includes one or more of a socket, plug or the like coupled with a circuit board, and the circuit board is, in turn, coupled with the solenoid 314. As further shown in FIG. 4C, the valve coupler 402 is decoupled from the valve body 400 and positioned away therefrom with one or more interposing gaskets 412, 414 also shown.

Referring again to FIG. 4C, the valve operator 312 includes a recessed surface 408 having one or more interface breaking projections 414 extending therefrom. In this example, the recessed surface 408 and the one or more interface breaking projections are provided as the end surface 407. In other examples, these features are provided on one or more other or additional surfaces of the valve operator 312 (or as described herein with surfaces surrounding the operator cavity 411). For instance, where a surface or end surface of the valve operator 312 is described herein the corresponding surfaces of the valve operator include, but are not limited to, those surfaces (end surfaces, side surfaces or the like) configured for engagement or positioning adjacent to opposed surfaces forming the perimeter of the operator cavity 411. The recessed surface 408, in one example, has a recessed surface area assuming a larger ratio of the end surface 407 relative to a corresponding projection surface area of the interface projections 414. For instance, in one example, the recessed surface area has a ratio relative to the projection surface area of 9:1. In another example, the proportion of the surface area of the projections 414 relative to the recessed surface 408 area is 1:4. In other examples, the area ratio of the interface breaking projections 414 relative to the recessed surface 408 varies between these ratios.

As shown in FIG. 4C, the interface breaking projections 414 are, in one example, a plurality of posts extending away from the recessed surface 408. In another example, the interface breaking projections 404 include one or more of corrugations, posts, knurling, ridges, bosses, rings or the like provided on the recessed surface 408 and extending therefrom to accordingly provide a discontinuous nonplanar surface (an interface breaking surface 416 in FIG. 4D) at the end surface 407 of the valve operator 312. The discontinuities formed by the one or more projections 414 and the recessed surface 408 minimize adhesion and vacuum interfaces or the like between the valve operator (e.g., at the end surface

407) and one or more surfaces of the valve assembly 302, such as the valve operator socket surface 409 previously shown in FIG. 4B.

FIG. 4D shows a detailed perspective view of the valve operator 312 previously shown in FIGS. 4B and 4C. In the example view shown, the valve operator 312 includes the operator surface 406 at one end of the valve operator 312 and an interface breaking surface 416 provided at the end surface 407 of the valve operator 312, in this example at an opposed end to the operator surface 406 (as described herein, the end surface or surface of the valve operator includes one or more surfaces of the valve operator 312). As previously described herein, the interface breaking surface 416 includes a recessed surface 408 and one or more interface breaking projections 414. The interface breaking surface 416 is configured to facilitate the movement of the valve operator 312 within the valve assembly 302, for instance, during oscillating movement corresponding to one or more duty cycles of the valve assembly 302 to accurately and reliably control the flow rate through the valve assembly 302.

Referring again to FIG. 4D, the valve operator 312, as previously described, includes an operator surface 406. In one example, the operator surface 406, including an optional gasket, plug or the likes is configured to seat along a corresponding portion of the valve housing 400 (FIG. 4C) having one or more valve inputs 306 and valve outputs 308. Seating of the operator surface 406 along the valve housing 400 closes communication between each of the valve inputs 306 and the valve outputs 308. In one example, seating of the operator surface 406 closes the valve output 308 while pressurized fluid from the valve inputs 306 is allowed to flow around the valve operator 312. The operator 312 optionally includes one or more infiltration passages 416 extending along the valve operator 312 toward the interface breaking surface 416. Pressurized fluid (e.g., from one or more pumps 204, 208), such as a mixed agricultural product, carrier fluid, an injectant product or the like is delivered through the valve input 306 (again shown in FIG. 4C) and along the infiltration passages 416 to the recessed surface 408. interpositioning of the pressurized fluid therein provides a bias (alternative to or in in addition to a biasing element, such as a spring) configured to assist with movement of the valve operator 312, for instance, from its engagement in an open configuration with the valve operator socket surface 409 (shown in FIG. 4B) to the closed position with the operator surface 406 seated along the valve housing 400 over one or more of the valve inputs 306 and valve outputs 308.

As further shown in FIG. 4D, the valve operator 312 includes the recessed surface 408 and the one or more interface breaking projections 414 extending from the recessed surface 408. In one example, with the valve operator 312 in an upper configuration, for instance, with the interface breaking surface 416 adjacent to and engaged with the valve operator socket surface 409 (see FIG. 4B) the interface breaking projections 414 and the recessed surface 408 cooperate to minimize adhesion based interfaces or vacuum based interfaces between the operator 312 and at least the valve operator socket surface 409. Instead, the one or more interface breaking projections 414 provide minimal surface-to-surface contact between the valve operator 312 and the valve operator socket surface 409 to facilitate the decoupling of the valve operator 312 from the valve operator socket surface 409, for instance, to move the valve operator 312 from the open configuration (corresponding to the upper position) to the lower position corresponding to the closed configuration in this example.

In the example shown in FIG. 4D, the interface breaking projections 414 include, but are not limited to, one or more of posts, corrugations, knurling, ridges, bosses, rings or the like projecting from the recessed surface 408. Correspondingly, the recessed surface 408 includes, but is not limited to, one or more of a planar surface, a scalloped surface, corrugations (troughs of the corrugations), a surface having channels, grooves, texture or the like.

In some examples, the ratio of the recessed surface 408 area relative to the projecting surface area of the interface breaking projections 414 is relatively high, for instance, with the recessed surface area having a ratio of 9:1 relative to the projecting surface area. In other examples, the ratio of the recessed surface area relative to the projection surface area is relatively small, for instance, with the recessed surface area and projecting surface area having a ratio of 1:4. Optionally, the recessed surface area and projecting surface area have a different ratio between the ratios of 9:1 and 1:4 previously provided herein. In still other examples, the recessed surface area has a larger surface area relative to the projecting surface area to facilitate the decoupling or interface breaking between the valve operator 312 (e.g., the end surface 407) and the valve operator socket surface 409.

Additionally, and as previously described herein, the infiltration passages 416 facilitate the delivery of a pressurized fluid, such as a pressurized agricultural product across the recessed surface 408 between the interface breaking surface 416 (including the recessed surface 408) and the valve operator socket surface 409. With the valve operator 312 in the upper (in one example, open) position, the pressurized agricultural product assists in biasing the valve operator 312 away from the valve operator socket surface 409. For instance, when current or voltage is interrupted to the solenoid 314 and the valve operator 312 is released, the interface breaking surface 416 readily decouples from the surface 409. Decoupling is further enhanced by the pressurized agricultural product provided across the recessed surface 408. Additionally, in at least some examples, the biasing element 410 cooperates with the pressurized fluid to further enhance decoupling and movement of the valve operator 312 in an instantaneous or near instantaneous fashion upon cessation of the current or voltage application to the solenoid 314. Accordingly, specified duty cycles and changes in duty cycles are accurately and rapidly reproduced at each of the valve assemblies 302, including the interface breaking surface 416 and optionally the infiltration passages 416 as described herein. Because of the accurate and rapid responsiveness of the valve assemblies 302 corresponding flow rates and changes in flow rates are achieved with the valve assemblies 302.

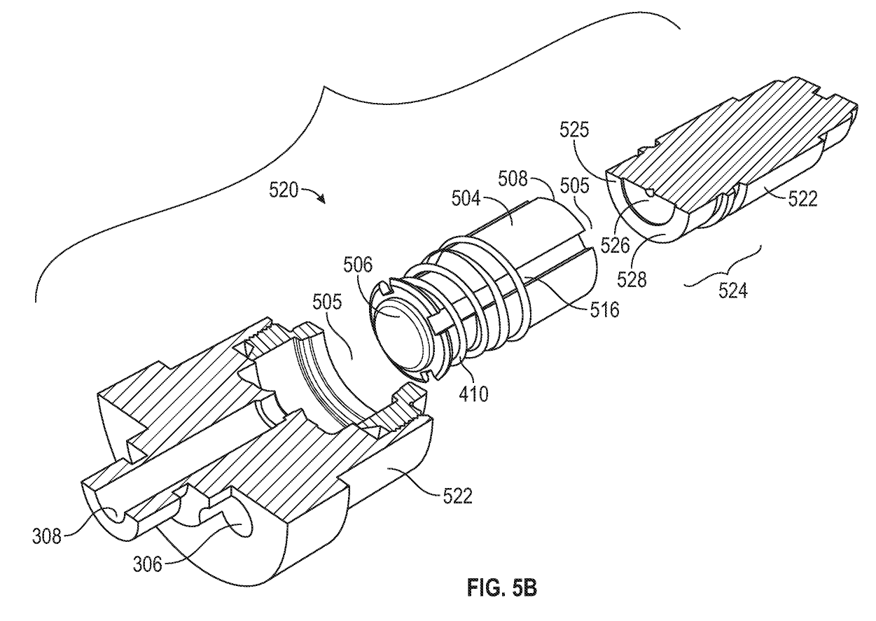

FIGS. 5A and 5B show other examples of valve assemblies 500, 520. As previously described herein, in an the end surface 407 of the valve operator 312 includes an interface breaking surface 416 having one or more interface breaking projections 414 and a recessed surface 408. In another example, the interface breaking surface is provided on another surface of the valve assembly. For instance, in the valve assembly 500 and the valve assembly 520 the interface breaking surfaces 510, 524 are provided on the valve body 502 (or 522) shown in FIG. 5A (or 5B) and extend along a portion of the operator cavity 505. In these examples, the end surfaces 508 of each of the valve operators 504 provided in the valve assemblies 500, 520 are, in one example, planar. In other examples, the end surfaces 508 have one or more discontinuities, for instance, in the manner of the interface breaking projections 414 and the recessed surface 408 shown, for instance, in FIGS. 4C and 4D. As previously described herein the surfaces or end surfaces of the valve operators 504 optionally include interface breaking surfaces that facilitate the breaking of one or more of adhesive or vacuum based interfaces between the valve operators 504 and the valve operator socket surfaces (including, but not limited to, surfaces 511, 525) of the valve cavity 505.

Referring now to FIG. 5A, the valve assembly 500 is in a partially exploded view with the valve body 502 (including a portion of the solenoid operator, in one example) spaced apart from another portion of the valve body 502. The valve operator 504 is provided therebetween. The valve assembly 500 includes one or more valve inlets 306 and a valve outlet 308 opening into the operator cavity 505 configured for slideable reception of the valve operator 504. The opposed portion of the valve body 502, for instance, corresponding to the solenoid includes a valve operator socket surface 511.

In this example, the valve operator socket surface 511 shown in FIG. 5A is also the interface breaking surface 510 and includes a recessed surface 512 and one or more interface breaking projections 514 extending from the recessed surface 512. As previously described herein, the interface breaking projections 514 include, but are not limited to, one or more of posts, corrugations, knurling, ridges, bosses, rings or the like extending from the recessed surface 512. The interface breaking projections 514, in combination with the recessed surface 51.2, provide discontinuities along the valve operator socket surface 511 that assist in breaking one or more of a vacuum or adhesion based interface between the valve operator 504 and the valve body 502, such as the valve operator socket surface 511.

Additionally, in other examples, the recessed surface 512, in combination with the interface breaking projections 514, cooperates with one or more infiltration passages 516 provided, for instance, along the valve operator 504 or a surrounding portion of the valve body 502 (surrounding the valve operator) to facilitate the delivery of pressurized fluid (e.g., pressurized agricultural product) between the end surface 508 of the valve operator 504 and the valve operator socket surface 511 of the valve body 502. Accordingly, in a similar manner to the valve assembly 302 previously shown and described in FIGS. 4A-D, in an upper position, for instance, with the valve operator 504 engaged with the valve operator socket surface 511, the delivery of pressurized fluid across the recessed surface 512 facilitates the breaking of the interface between the end surface 508 and the valve operator socket surface 511 and accordingly facilitates the accurate and rapid response of the valve operator 504 when released after the current, voltage or the like to a solenoid control element is interrupted.

FIG. 5B shows another example of a valve assembly 520. The valve assembly 520 shown in FIG. 5B is similar, in at least some regards, to the previously described valve assemblies 302, 500. For instance, the valve assembly 520 includes a valve body 522 including one or more valve inlets 306 and valve outlets 308. Additionally, a valve operator 504 is moveably positioned within an operator cavity 505 of the valve body 522. In the example shown in FIG. 5B, the valve body 522 is shown in two pieces, for instance, with a portion of the valve body 522 provided proximate an end surface 508 and including a portion of the operating mechanism, for instance, a solenoid. The opposed portion of the valve body 522 includes the inlets 306 and the outlets 308 previously described herein.

In the example shown in FIG. 5B, the valve operator socket surface 525 again includes the interface breaking surface 524 of the valve assembly 520. In this example the interface breaking projection 528 is a ring extending around the recessed surface 526 and thereby providing a nonplanar surface for the valve operator socket surface 525 to cooperate with the end surface 508 in breaking a vacuum or adhesion based interface between the valve operator 504 and the valve body 522. Although FIG. 5B shows the valve operator socket surface 525, including a ring based interface breaking projection 528, in other examples, the valve operator socket surface includes one or more projections 528 including, but not limited to, corrugations, posts, narrowing, ridges, rings or the like. Additionally, the recessed surface 526 (as well as the recessed surface 512 shown in FIG. 5A) include one or more features including, but not limited to a planar surface, scallops, channels, grooves or the like configured to cooperate with the interface breaking projections 528 including a single ring, multiple rings, multiple posts or the like to facilitate the breaking of the interface between the valve operator 504 and the valve operator socket surface 525. The operator socket surfaces 511, 525 and respective interface breaking surfaces 510, 524 are shown in these examples as facing an end surface 508 of the valve operator 504 in FIGS. 5A, B. In other examples the operator socket surfaces and respective interface breaking surfaces (including one or more projections and recessed areas as described herein) are provided along surfaces surrounding the valve cavity 505 that are otherwise prone to adhesion or vacuum based interfaces with the valve operator 504. Similarly, one or more interface breaking surfaces are optionally provided at locations along the valve operators described herein (312, 504) to facilitate the breaking of interfaces on surfaces of the valve operators that are otherwise prone to vacuum and adhesion based interfaces.

In this example, the infiltration passages 516 extend along the valve operator 504 to the interface between the valve operator socket surface 525 and the end surface 508 of the operator 504. Optionally, the infiltration passages 516 are sufficiently deep are provided on the interior of the valve operator 504 to facilitate the delivery of the pressurized fluid such as an agricultural product to the recessed surface 526 of the valve operator socket surface 525 and thereby facilitate the application of the pressurized fluid there between to bias (in addition, for instance, to the biasing element 410) the valve operator away from the valve operator socket surface 525 during operation. In another example, and as previously described herein, the end surface 508 has its own discontinuities, for instance, one or more of interface breaking projections 414 extending from a recessed surface 408 as shown in FIGS. 4C and 4D to allow the flow of the pressurized fluid between the valve operator socket surface 525 and the end surface 508.

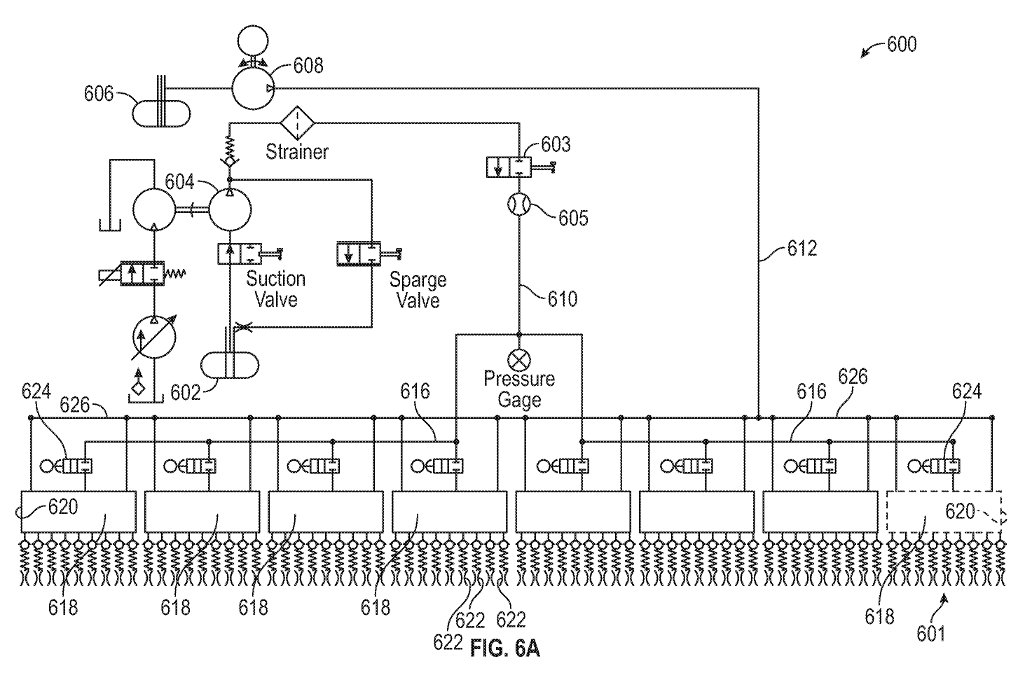

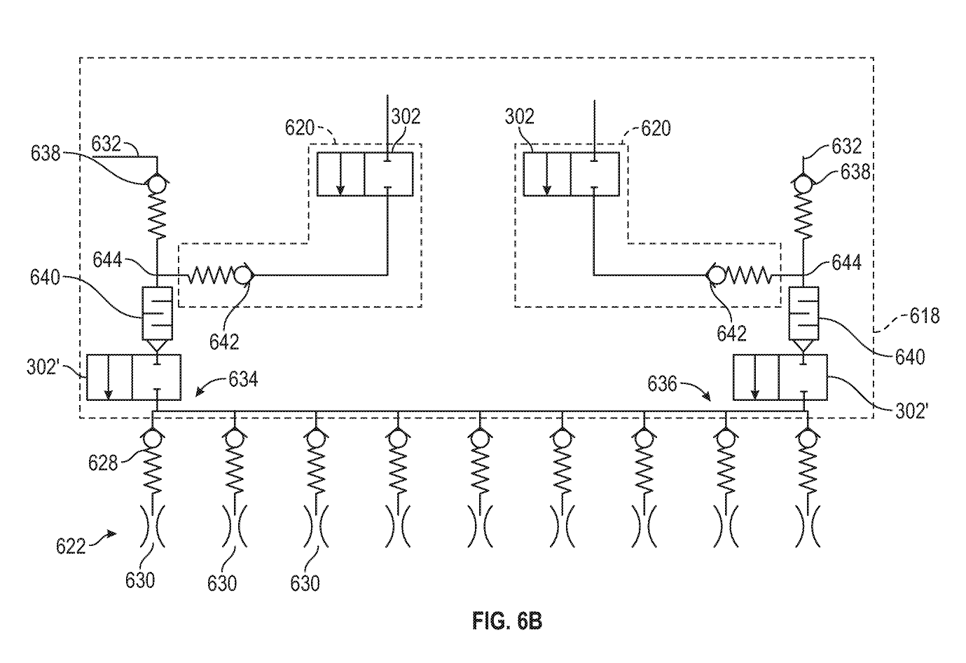

FIG. 6A shows a detailed example of a sprayer 600 including a localized product injection system 601 that maintains each of the carrier fluid and at least one injection product isolated from the other, and mixes the fluid and product together downstream relative to the configuration shown in FIG. 2A. The localized product injection system 601 facilitates real time (including near real time) mixing of the injection product with the carrier fluid to achieve specified concentrations of the injection product without appreciable delay.

In the example shown in FIG. 6A the localized product injection system 601 is in a boom section format. For instance, the injection interfaces 620 (including one or more of the valve assemblies described herein) are coupled with one or more boom sections 618 along the sprayer booms 102. As further shown FIG. 6A, the carrier reservoir 602 (e.g., with a carrier fluid, such as water, therein) communicates with the carrier pump 604. The carrier pump 604 pressurizes the carrier fluid and delivers it within a carrier header 610 to the boom sections 618 of the sprayer booms 102. In one example, a carrier flow control valve 603 and a flow meter 605 are provided along the carrier header 610. The flow meter 605 cooperates with the carrier flow control valve 603 (e.g., with an intervening controller) to measure the output flow from the carrier reservoir 602 (produced by the carrier pump 604) and to facilitate actuating of the carrier flow control valve 603 to achieve the specified flow rate of carrier fluid to the boom tubes 616 and the plurality of boom sections 618 described herein. As further shown in FIG. 6A the carrier header 610 extends to the boom tubes 616 extending to the left and right of the carrier header 610. Each of the boom tubes 616 in turn feeds into the boom sections 618, and the boom sections 618 each have corresponding nozzle assemblies 622. Optionally, section valves 624 are interposed between each boom section 618 and the corresponding boom tubus 616. The sections valves 624 facilitate control of the carrier fluid flow to each of the boom sections 618.

As described herein and shown in the example provided in FIG. 6A, the valve assemblies, including one or more interface breaking surfaces, are optionally provided in the injection interfaces 620 coupled with the boom sections 618 and thereby provide individualized and independent control of the injection product to each of the boom sections 618 relative to the other boom sections.

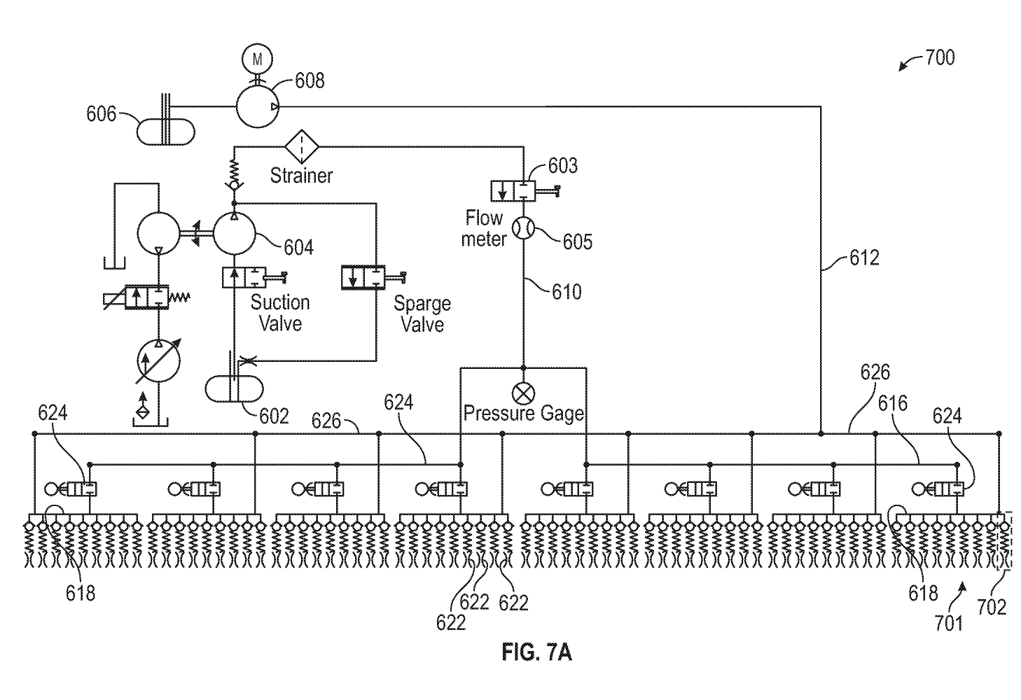

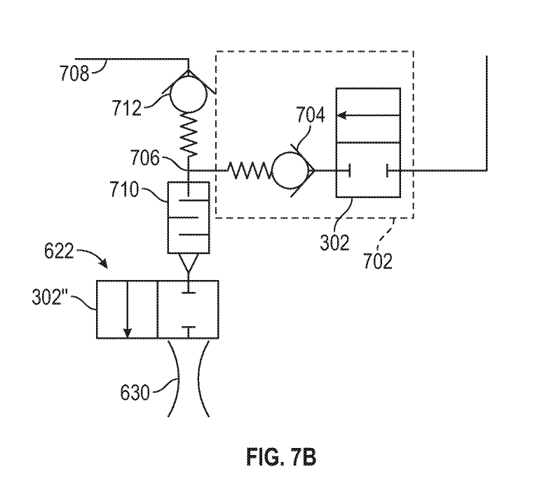

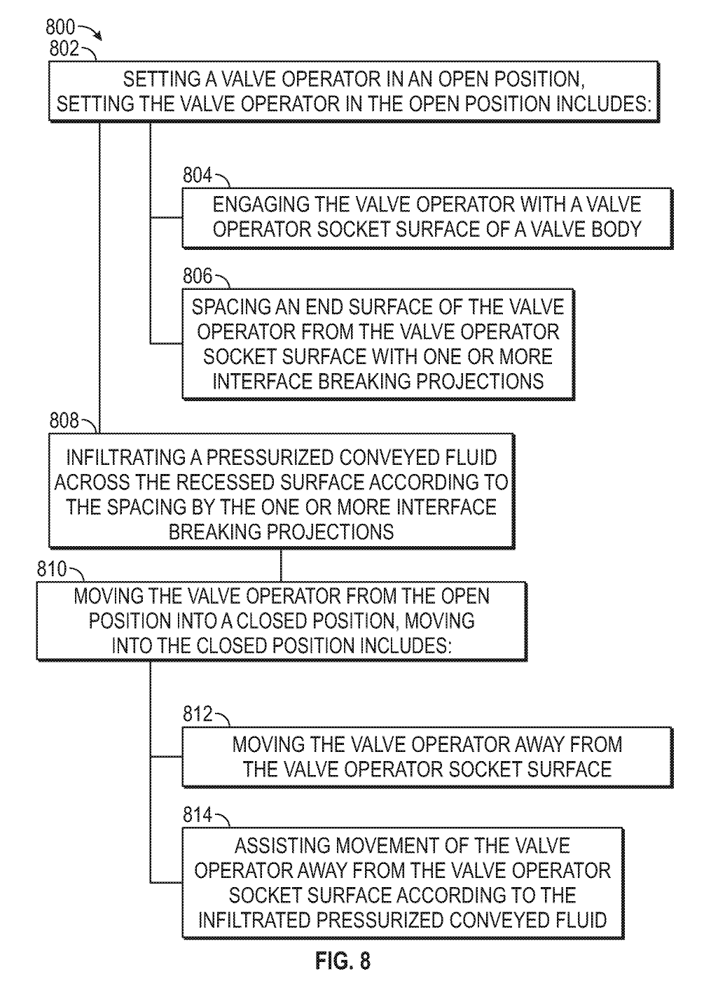

In this example, the injection product reservoir 606 communicates with an injection pump 608. The injection pump 608 delivers the injection product (e.g., one or more additives including, but not limited to fertilizers, nutrients, herbicides, pesticides or the like) from the reservoir 606 to an injection header 612. The injection header 612 delivers the injection product to one or more injection boom tubes 626 extending to the left and right as shown in FIG. 6A. The injection boom tubes 626 distribute the injection product to the injection interfaces 620 independently from the carrier fluid. As previously described, the injection interfaces 620 deliver the injection product directly to each of the product dispensers (e.g., the boom sections 108 or in the example shown in FIG. 7A, nozzle assemblies).

As shown in FIG. 6A the localized product injection system 601 is isolated from the carrier fluid (e.g., carrier header 610, boom tubes 612 and the like) until localized introduction of the injection product at the injection interfaces 620. Accordingly, the localized product injection system 601 maintains a pressurized environment for the injection product to the injection interfaces 620 (e.g., with the injection pump 608). At the injection interfaces 620 the pressurized injection product is delivered to each of the product dispensers (boom sections 618 in FIG. 6A and nozzle assemblies in FIG. 7A) as determined, for instance, by a controller. Even in low flow situations with a low flow of carrier fluid, metered by the flow meter 605 and the carrier flow control valve 603, the injection product is provided in a pressurized manner and is thereby ready for instantaneous delivery to one or more of the boom sections 618. Accordingly, individualized and instantaneous control of the injection product (e.g., concentration of the injection product relative to the carrier fluid) is achieved for each of the product dispensers including the boom sections 618. The injection product is provided from the injection interfaces 620 locally relative to the boom sections 618 and remote from the upstream carrier reservoir 602.

Referring now to FIG. 6B, a detailed view of one of the boom sections 618 with injection interfaces 620 as previously shown in FIG. 6A is provided. The boom section 618 extends from left to right on the page and includes a plurality of nozzle assemblies 622. In one example, the nozzle assemblies 622 each include a nozzle check valve 628 and a corresponding nozzle 630 (e.g., an atomizer nozzle, stream nozzle, multiple nozzle assembly as shown in FIG. 3 or the like). In the example shown in FIG. 6B, nine nozzle assemblies 622 are provided in a spaced configuration along the boom section 618. Carrier lines 632 introduce carrier fluid to each of the boom section first and second ends 634, 636. In one example each of the carrier lines 632 includes a check valve 638 and a mixer 640, such as a static mixer.

The localized product injection system shown in FIG. 2B includes the injection interfaces 620. In the example shown in FIG. 2B, an injection interface 620 is associated with each of the carrier lines 632 (the carrier lines extending from the boom tube 616 and the carrier header 610 to the boom section 618). Each of the injection interfaces 620 delivers injection product to the associated carrier line 632 in communication with the boom section first and second ends 634, 636.

In one example, the injection interfaces 620 include valve assemblies 302 (or 500, 502) in series with check valves 642. In one example the valve assemblies include valve operators 312 configured to provide a metered flow of the pressurized injection product through the injection interfaces 620 to injection ports 644 in communication with each of the carrier lines 632. In one example the actuation of the valve assemblies 302, for instance to a desired flow rate, delivers the specified amount of injection product to each of the corresponding carrier lines 632 at the injection ports 644. The solution of the carrier fluid and the injection product is delivered through the mixers 640 and mixed prior to delivery to the boom section 618 (e.g., the nozzle assemblies 622). The mixed solution of the carrier fluid and the injection product (the agricultural product having a concentration controlled by the flow rate of the injection product) is delivered from the boom section first and second ends 64, 636 throughout the boom section 618 and to each of the nozzle assemblies 622. Accordingly, each of the nozzle assemblies 622 associated with a particular boom section 618 delivers substantially the same agricultural product having the same injection product concentration.

Because each of the valve assemblies 302 (e.g., in example configurations shown with at least assemblies 302, 500, 502) includes one or more interface breaking surfaces between the valve operator end surface 407 and the operator socket surface 409 vacuum or adhesion based interfaces between these surfaces are reliably overcome. For instance, even with viscous (e.g., tacky) agricultural products including injections products, carrier fluids, mixtures of the same or the like the interface breaking surfaces facilitate reliable separation between surfaces when the valve operator 312 is moved. The interface breaking projections and recessed surfaces, on one or both of the operator 312 or the valve body 302, minimize adhesion interfaces and also retain pressurized fluid between the surfaces to assist in biasing the operator 312 from the valve operator socket surface 409. Accordingly, the valve assemblies 302 are responsive (even with viscous fluids) and provide instantaneous including near instantaneous) changes in concentration to the carrier fluid at the injection ports 644 locally relative to the nozzle assemblies 622.

The injection interfaces 620 associated with the boom section 618 are operated independently relative to other injection interfaces 620 associated with other boom sections 618 of the sprayer 600.Accordingly individualized control and instantaneous delivery of the injection product (e.g., to regulate concentration of the injection product) to the boom sections 618 is achieved for each of the boom sections 618.

In another example, the boom section 618 further includes one or more valve assemblies 302′ downstream from the injection ports 644. The one or more valve assemblies 302′ include features similar to those of assemblies 302, 500, 502, including one or more interface breaking surfaces (e.g., discontinuous surfaces having one or more of posts, knurling, grooves, ridges, recesses or the like) that facilitate the reliable breaking of adhesion and vacuum interfaces. Like the valve assemblies 302 associated with the injection product, the valve assemblies 302′ are also optionally operated based on a specified flow rates of the mixed agricultural product. For instance, the valve assemblies 302′ (and optionally the injection valve assemblies 302) including valve operators 312 are operated across a range of duty cycles to provide a corresponding flow rate to the nozzle assemblies 622 (and related spray pattern and flow rate to each nozzle 630). The interface breaking surfaces, pressurized fluid between the operator and valve body 400 surfaces (e.g., end surface 407 and valve operator socket surface 409), ensure responsive operation of the valve assemblies 302′ (and 302) across a range of duty cycles and flow rates without adhesion, sticking or seizing of the valve operators. The injection product and the mixed agricultural product are thereby delivered instantaneously at the specified flow rates controlled by the respective valve assemblies 300, 302′ to each of the nozzle assemblies 622.

FIG. 7A shows another example of a sprayer 700. The example shown in FIG. 7A is similar in at least some regards to the sprayer 600 previously shown and described in FIGS. 6A, B. For instance, the sprayer 700 shown in FIG. 7A includes an isolated localized product injection system 701 that is separate from the carrier header 610, boom tubes 616 for the carrier fluid and the like. As previously described herein, the localized product injection system 701 delivers an injection product from the injection product reservoir 606 to a plurality of boom sections 618. As shown in FIG. 7A and further shown in FIG. 7B, the injection interfaces 702 are each in communication with corresponding nozzle assemblies 622. Stated another way, the product dispensers in the example shown in FIGS. 7A and 7B are the nozzle assemblies 622. Accordingly individualized control and instantaneous injection of the injection product (including near instantaneous injection relative to an instruction specifying a duty cycle or flow rate) are provided at each of the nozzle assemblies 622. Each of the injection interfaces 702, for instance along the length of the sprayer booms 102, are independently controlled according to specified concentrations of the injection product within the carrier fluid. The dispensed agricultural product from each of the nozzle assemblies 622 thereby has an independently controlled concentration of the injection product based on the independent control of the concentration provided by the injection interfaces 702.

Referring now to FIG. 7B, another example of an injection interface 702 is provided. The injection interface 702 includes a valve assembly 302 (or 500, 502) and a check valve 704. In contrast to the previously described example, the injection interface 702 in this example includes an injection port 706 provided at the nozzle assembly 622 and downstream from a carrier line 708 communicating with the boom section 618 or boom tube 616. The nozzle assembly 622 includes a nozzle 630, a valve assembly 302″ an in-line mixer 710 (e.g., a static mixer) and a check valve 712 between the injection port 706 and the nozzle 630. The nozzle 630 includes one or more of an atomizer or stream nozzle (or multiple nozzle assembly) in communication with the mixer 710. As shown in FIG. 7B, the injection port 706 is coupled with the nozzle assembly 622. For instance the injection port 706 is interposed between the check valve 712 and the mixer 710.

In operation, the injection product is delivered through the injection boom tubes 626 to each of the injection interfaces 702. The valve assemblies 302 of each of the injection interfaces 702 meter the amount of injection product delivered to the corresponding nozzle assembly 622. For instance, the injection product is independently metered for each of the injection interfaces 702 according to control signals from a controller associated with each of the injection interfaces 702. The controller is configured to control each of the injection interfaces independently or in one or more groups or arrays. The injection product is delivered from the valve assembly 302 through the check valve 704 and into the nozzle assembly 622 through the injection port 706. Prior to delivery through the nozzle 630 the injection product in combination with the carrier fluid is optionally mixed within the mixer 710 and thereafter delivered through the nozzle 630 as the agricultural product having the specified concentration of the injection product.

In a similar manner to the localized product injection system 601 shown in FIGS. 6A, B the localized product injection system 701 shown in FIGS. 7A, B is configured to provide an instantaneous (including near instantaneous) addition of an injection product to the carrier fluid stream immediately prior to its dispensing through the nozzle 630 (e.g., local to the product dispenser, in this example the nozzle assembly 622). Accordingly, instantaneous changes in concentration or flow rate of the injection product in an agricultural product, for instance for differing parts of a field, differing flow rates of the carrier fluid or the like, are achieved on an instantaneous as-needed basis as the sprayer 700 moves through the field. With independent control of the injection product concentration at each of the nozzle assemblies 622 increased resolution is provided on a scale of one or more nozzles 630 (corresponding to one or more crop rows).

Further, because each of the valve assemblies 302, 302″ (e.g,, in example configurations shown with at least assemblies 302, 500, 502) includes one or more interface breaking surfaces between the valve operator end surface 407 and the operator socket surface 409 vacuum or adhesion based interfaces between these surfaces are reliably overcome. Even with viscous (e.g., tacky) agricultural products including injection products, carrier fluids, mixtures of the same or the like the interface breaking surfaces facilitate reliable separation between surfaces when the valve operator 312 is moved. The interface breaking projections and recessed surfaces, on one or both of the operator 312 or the valve body 302, minimize adhesion interfaces and also retain pressurized fluid between the surfaces to assist in biasing the operator 312 away from the valve operator socket surface 409, for instance upon closing of the valve assembly 302 (with interruption of current to a solenoid). Accordingly, the valve assemblies 302 are responsive (even with viscous fluids) and provide instantaneous (e.g., including near instantaneous) changes in concentration to the carrier fluid at the injection ports 644 locally relative to the nozzle assemblies 622.

Additionally, and as described herein, the valve assemblies 302, 302′ including valve operators 312 are operated (oscillated) across a range of duty cycles to provide a corresponding flow rate of the injection product and the mixed agricultural product to the nozzle assemblies 622 (and related spray pattern and flow rate to each nozzle 630). The interface breaking surfaces, pressurized fluid between the operator and valve body 400 surfaces (e.g., end surface 407 and valve operator socket surface 409), ensure responsive operation of the valve assemblies 300, 302′ across a range of duty cycles and flow rates without adhesion, sticking or seizing of the valve operators. The mixed agricultural product is thereby delivered instantaneously and at the specified flow rate controlled by the valve assemblies 300, 302′ to each of the nozzle assemblies 622.

FIG. 8 shows one example of a method 800 for operating a valve assembly. In describing the method 800, reference is made to one or more components, features, functions, steps or the like described herein. Where convenient, reference is made to the components, features, steps, functions or the like with reference numerals. Reference numerals provided are exemplary and are not exclusive. For instance, the features, components, functions, steps or the like described in the method 800 include, but are not limited to, the corresponding numbered elements, other corresponding features described herein (both numbered and unnumbered) as well as their equivalents.

At 802 a valve operator 312 is in an open position. Setting the valve operator 312 in the open position includes, at 804, engaging the valve operator 312 with a valve operator socket surface 409 of a valve body 400. For instance, an operator surface 406 of the valve operator 312 is spaced from one or more valve inputs 306 and outputs 308 to provided communication therebetween. At 806, in the open position a surface of the valve operator 312, such as the end surface 407, is spaced from the valve operator socket surface 409 with one or more interface breaking projections 414 extending from a recessed surface 408.

At 808, a pressurized conveyed fluid is infiltrated across the recessed surface 408 according to the spacing by the one or more interface breaking projections 414. The pressurized conveyed fluid is interposed between the valve operator 312 and one or more surfaces of the valve cavity 411 (e.g., the valve operator socket surface 406).

At 810 the method 800 includes moving the valve operator 312, for instance, from the open position into a closed position. Moving the valve operator 312 includes at 812 moving the valve operator 312 away from the valve operator socket surface 406 (one or more surfaces extending along the valve cavity 411). At 814, movement of the valve operator 312 (e.g., away from the valve operator socket surface 406) is assisted with the infiltrated pressurized conveyed fluid between surfaces of the valve operator 312 and the valve cavity 411.

Several options for the method 800 follow. In one example, setting the valve operator in the open position includes delivering a current through a solenoid coil (e.g., solenoid 314) and setting the valve operator 312 in the open position according to the current. In another example, moving the valve operator 312 into the closed position includes arresting delivery of current through the solenoid 314 and moving the valve operator 312 into the closed position according to a biasing element. Optionally, moving the valve operator 312 into the closed position includes reversing the current through the solenoid 314 and moving the valve operator 312 into the closed position according to the reversed current.

In another example, infiltrating the pressurized conveyed fluid across the recessed surface, such as the surface 408, includes aborting one or more of an adhesion or vacuum interface between the valve operator 312 and the valve operator socket surface 409 (including one or more surfaces of each of the valve operator 312 and the valve cavity 411 otherwise prone to adhesion).

In some examples described herein setting the valve operator 312 in the open position includes conveying or allowing the conveyance of the conveyed fluid, such as an agricultural product, from a fluid inlet 306 to a fluid outlet 308. In these examples, moving the valve operator 312 from the open position into the closed position includes isolating the fluid inlet 306 from the fluid outlet 308.

### VARIOUS NOTES & EXAMPLES

Example 1 includes subject matter such as a valve assembly comprising: a valve body including a fluid inlet and a fluid outlet; an operator cavity within the valve body, the valve body includes a valve operator socket surface; a valve operator within the operator cavity, the valve operator is slidably coupled with the valve body, the valve operator includes an operator surface configured to selectively isolate the fluid inlet from the fluid outlet; and wherein at least one of the valve operator socket surface of the valve body or a surface of the valve operator include a discontinuous interface, the discontinuous interface includes: a recessed surface, and one or more interface breaking projections extending from the recessed surface, the one or more interface breaking projections space the recessed surface from the valve operator socket surface.

Example 2 can include, or can optionally be combined with the subject matter of Example 1, to optionally include wherein the surface of the valve operator includes an end surface having the discontinuous interface.

Example 3 can include, or can optionally be combined with the subject matter of one or any combination of Examples 1 or 2 to optionally include wherein the valve operator socket surface includes the discontinuous interface.

Example 4 can include, or can optionally be combined with the subject matter of one or any combination of Examples 1-3 to optionally include wherein each of the valve operator socket surface and the surface of the valve operator include the discontinuous surface.

Example 5 can include, or can optionally be combined with the subject matter of one or any combination of Examples 1-4 to optionally include wherein the one or more interface breaking projections include one or more of a post, ridge, boss, knurling, corrugation peak or ring.

Example 6 can include, or can optionally be combined with the subject matter of Examples 1-5 to optionally include wherein the recessed surface includes one or more of a plane, scallop, channels, corrugation trough or groove.

Example 7 can include, or can optionally be combined with the subject matter of Examples 1-6 to optionally include wherein the recessed surface includes a recessed surface area greater than a projection surface area of the one or more interface breaking projections.

Example 8 can include, or can optionally be combined with the subject matter of Examples 1-7 to optionally include wherein the recessed surface includes a recessed surface area and the one or more interface breaking projections include a projection surface area, and a ratio of recessed surface area to projection surface area is between 9:1 to 1:4.

Example 9 can include, or can optionally be combined with the subject matter of Examples 1-8 to optionally include wherein the recessed surface includes a recessed surface area and the one or more interface breaking projections include a projection surface area, a ratio of recessed surface area to projection surface area is is between 9:1 to 1:2.

Example 10 can include, or can optionally be combined with the subject matter of Examples 1-9 to optionally include wherein the valve operator is configured for movement between closed and open positions with respect to one or more of the fluid inlet and the fluid outlet: in the open position the valve operator is biased away from each of the fluid inlet and the fluid outlet, and the one or more interface breaking projections space the surface of the valve operator from the valve operator socket surface, and in the closed position the surface of the valve operator is remote from the valve operator socket surface and the operator surface isolates the fluid inlet from the fluid outlet.

Example 11 can include, or can optionally be combined with the subject matter of Examples 1-10 to optionally include wherein the one or more interface breaking projections include an interface breaking surface distributed over a portion of the recessed surface.

Example 12 can include, or can optionally be combined with the subject matter of Examples 1-11 to optionally include wherein the recessed surface is configured to receive a pressurized conveyed fluid, the pressurized conveyed fluid between the surface of the valve operator and the valve operator socket surface according to the one or more interface breaking projections.

Example 13 can include, or can optionally be combined with the subject matter of Examples 1-12 to optionally include wherein the recessed surface and the one or more interface breaking projections are configured to assist with biasing of the valve operator between an open position and a closed position according to conveyed pressurized fluid between the surface of the valve operator and the valve operator socket surface.

Example 14 can include, or can optionally be combined with the subject matter of Examples 1-13 to optionally include wherein the recessed surface and the one or more interface breaking projections are configured to abort one or more of a vacuum or adhesion based interface between the valve operator and the valve operator socket surface.

Example 15 can include, or can optionally be combined with the subject matter of Examples 1-14 to optionally include a solenoid coil coupled with the valve body, the solenoid coil is configured to bias the valve operator toward at least one of open and closed positions.

Example 16 can include, or can optionally be combined with the subject matter of Examples 1-15 to optionally include a biasing element coupled with the valve operator, the biasing element is configured to bias the valve operator toward the closed position.

Example 17 can include, or can optionally be combined with the subject matter of Examples 1-16 to optionally include an agricultural product fluid reservoir in communication with the fluid inlet and a dispensing nozzle in communication with the fluid outlet.

Example 18 can include, or can optionally be combined with the subject matter of Examples 1-17 to optionally include an agricultural product injectant fluid reservoir in communication with the fluid inlet and an injector port in communication with the fluid outlet, the injector is configured to inject agricultural product injectant into a carrier fluid passage.

Example 19 can include, or can optionally be combined with the subject matter of Examples 1-18 to optionally include a dispensing nozzle in communication with the carrier fluid passage, and the dispensing nozzle is configured to dispense the carrier fluid with the injected agricultural product injectant therein.

Example 20 can include, or can optionally be combined with the subject matter of Examples 1-19 to optionally include wherein the dispensing nozzle is immediately adjacent to the fluid outlet of the valve body.

Example 21 can include, or can optionally be combined with the subject matter of Examples 1-20 to optionally include wherein the valve operator is a poppet valve operator. Example 22 can include, or can optionally be combined with the subject matter of Examples 1-21 to optionally include a valve assembly comprising: a valve body including a fluid inlet and a fluid outlet; an operator cavity within the valve body, the valve body includes a valve operator socket surface; a valve operator within the operator cavity, the valve operator slidably coupled with the valve body, the valve operator includes: an operator surface, a recessed surface, and one or more interface breaking projections extending from the recessed surface; and the valve operator is configured for movement between closed and open positions with respect to one or more of the fluid inlet and the fluid outlet: in the open position the valve operator is biased away from each of the fluid inlet and the fluid outlet, and the one or more interface breaking projections space the recessed surface from the valve operator socket surface, and in the closed position the valve operator is remote from the valve operator socket surface and the operator surface isolates the fluid inlet from the fluid outlet.

Example 23 can include, or can optionally be combined with the subject matter of Examples 1-22 to optionally include wherein the one or more interface breaking projections include corrugations extending from the recessed surface, and the recessed surface includes grooves between the corrugations.

Example 24 can include, or can optionally be combined with the subject matter of Examples 1-23 to optionally include wherein the one or more interface breaking projections include one or more posts extending from the recessed surface.

Example 25 can include, or can optionally be combined with the subject matter of Examples 1-24 to optionally include wherein the one or more interface breaking projections include an interface breaking surface distributed over a portion of the recessed surface.

Example 26 can include, or can optionally be combined with the subject matter of Examples 1-25 to optionally include wherein the recessed surface and the one or more interface breaking projections are configured to receive a pressurized conveyed fluid, the pressurized conveyed fluid between the recessed surface and the valve operator socket surface.

Example 27 can include, or can optionally be combined with the subject matter of Examples 1-26 to optionally include wherein the recessed surface and the one or more interface breaking projections are configured to assist with biasing of the valve operator from the open position to the closed position according to conveyed pressurized fluid between the recessed surface and the valve operator socket surface.

Example 28 can include, or can optionally be combined with the subject matter of Examples 1-27 to optionally include wherein the recessed surface and the one or more interface breaking projections are configured to abort one or more of a vacuum or adhesion based interface between the valve operator and valve operator socket surface.

Example 29 can include, or can optionally be combined with the subject matter of Examples 1-28 to optionally include a solenoid coil coupled with the valve body, the solenoid coil is configured to bias the valve operator into at least one of the open and closed positions.

Example 30 can include, or can optionally be combined with the subject matter of Examples 1-29 to optionally include a biasing element coupled with the valve operator, the biasing element is configured to bias the valve operator into the closed position.

Example 31 can include, or can optionally be combined with the subject matter of Examples 1-30 to optionally include an agricultural product fluid reservoir in communication with the fluid inlet and a dispensing nozzle in communication with the fluid outlet.

Example 32 can include, or can optionally be combined with the subject matter of Examples 1-31 to optionally include an agricultural product injectant fluid reservoir in communication with the fluid inlet and an injector in communication with the fluid outlet, the injector is configured to inject the agricultural product injectant into a carrier fluid passage.

Example 33 can include, or can optionally be combined with the subject matter of Examples 1-32 to optionally include a dispensing nozzle in communication with the carrier fluid passage, and the dispensing nozzle is configured to dispense the carrier fluid and the injected agricultural product injectant therein.

Example 34 can include, or can optionally be combined with the subject matter of Examples 1-33 to optionally include wherein the dispensing nozzle is immediately adjacent to the fluid outlet of the valve body.

Example 35 can include, or can optionally be combined with the subject matter of Examples 1-34 to optionally include wherein the valve operator is a poppet valve operator.

Example 36 can include, or can optionally be combined with the subject matter of Examples 1-35 to optionally include wherein the one or more interface breaking projections include one or more of a post, ridge, boss, knurling or ring.

Example 37 can include, or can optionally be combined with the subject matter of Examples 1-36 to optionally include wherein the recessed surface includes one or more of a plane, scallops, channels or grooves.

Example 38 can include, or can optionally be combined with the subject matter of Examples 1-37 to optionally include wherein the recessed surface includes a recessed surface area greater than a projection surface area of the one or more interface breaking projections.

Example 39 can include, or can optionally be combined with the subject matter of Examples 1-38 to optionally include wherein the recessed surface includes a recessed surface area and the one or more interface breaking projections include a projection surface area, and a ratio of recessed surface area to projection surface area is between 9:1 to 1:4.

Example 40 can include, or can optionally be combined with the subject matter of Examples 1-39 to optionally include wherein the recessed surface includes a recessed surface area and the one or more interface breaking projections include a projection surface area, a ratio of recessed surface area to projection surface area is is between 9:1 to 1:2.

Example 41 can include, or can optionally be combined with the subject matter of Examples 1-40 to optionally include a method of operating a valve assembly comprising: setting a valve operator in an open position, setting the valve operator in the open position includes: engaging the valve operator with a valve operator socket surface of a valve body, and spacing an end surface of the valve operator from the valve operator socket surface with one or more interface breaking projections extending from a recessed surface; infiltrating a pressurized conveyed fluid across the recessed surface according to the spacing by the one or more interface breaking projections; and moving the valve operator from the open position into a closed position, moving into the closed position includes: moving the valve operator away from the valve operator socket surface, and assisting movement of the valve operator away from the valve operator socket surface according to the infiltrated pressurized conveyed fluid.

Example 42 can include, or can optionally be combined with the subject matter of Examples 1-41 to optionally include wherein setting the valve operator in the open position includes delivering a current through a solenoid coil and setting the valve operator in the open position according to the current.

Example 43 can include, or can optionally be combined with the subject matter of Examples 1-42 to optionally include wherein moving the valve operator into the closed position includes arresting delivery of the current through the solenoid coil and moving the valve operator into the closed position according to a biasing element.

Example 44 can include, or can optionally be combined with the subject matter of Examples 1-43 to optionally include wherein moving the valve operator into the closed position includes reversing the direction of the current through the solenoid coil and moving the valve operator into the closed position according to the reversed direction of the current.

Example 45 can include, or can optionally be combined with the subject matter of Examples 1-44 to optionally include wherein infiltrating the pressurized conveyed fluid across the recessed surface includes aborting one or more of an adhesion or vacuum interface between the valve operator and the valve operator socket surface.

Example 46 can include, or can optionally be combined with the subject matter of Examples 1-45 to optionally include wherein setting the valve operator in the open position includes conveying the conveyed fluid from a fluid inlet to a fluid outlet.

Example 47 can include, or can optionally be combined with the subject matter of Examples 1-46 to optionally include wherein moving the valve operator from the open position into the closed position includes isolating the fluid inlet from the fluid outlet.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the disclosure can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first.” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

What is claimed is:

1. A valve assembly comprising:
a valve body including a fluid inlet and a fluid outlet;
an operator cavity within the valve body, the valve body includes a valve operator socket surface;
a valve operator within the operator cavity, the valve operator is slidably coupled with the valve body, the valve operator includes an operator surface configured to selectively isolate the fluid inlet from the fluid outlet; and
wherein at least one of the valve operator socket surface of the valve body or a surface of the valve operator include a discontinuous interface, the discontinuous interface includes:
a recessed surface, and
one or more interface breaking projections extending from the recessed surface, the one or more interface breaking projections space the recessed surface from the valve operator socket surface.

2. The valve assembly of claim 1, wherein the surface of the valve operator includes an end surface having the discontinuous interface.

3. The valve assembly of claim 1, wherein the valve operator socket surface includes the discontinuous interface.

4. The valve assembly of claim 1, wherein each of the valve operator socket surface and the surface of the valve operator include the discontinuous surface.

5. The valve assembly of claim 1, wherein the one or more interface breaking projections include one or more of a post, ridge, boss, knurling, corrugation peak or ring.

6. The valve assembly of claim 1, wherein the recessed surface includes one or more of a plane, scallop, channels, corrugation trough or groove.

7. The valve assembly of claim 1, wherein the recessed surface includes a recessed surface area greater than a projection surface area of the one or more interface breaking projections.

8. The valve assembly of claim 1, wherein the recessed surface includes a recessed surface area and the one or more interface breaking projections include a projection surface area, and a ratio of recessed surface area to projection surface area is between 9:1 to 1:4.

9. The valve assembly of claim 1, wherein the recessed surface includes a recessed surface area and the one or more interface breaking projections include a projection surface area, a ratio of recessed surface area to projection surface area is is between 9:1 to 1:2.

10. The valve assembly of claim 1, wherein the valve operator is configured for movement between closed and open positions with respect to one or more of the fluid inlet and the fluid outlet:
in the open position the valve operator is biased away from each of the fluid inlet and the fluid outlet, and the one or more interface breaking projections space the surface of the valve operator from the valve operator socket surface, and
in the closed position the surface of the valve operator is remote from the valve operator socket surface and the operator surface isolates the fluid inlet from the fluid outlet.

11. The valve assembly of claim 1, wherein the one or more interface breaking projections include an interface breaking surface distributed over a portion of the recessed surface.

12. The valve assembly of claim 1, wherein the recessed surface is configured to receive a pressurized conveyed fluid, the pressurized conveyed fluid between the surface of the valve operator and the valve operator socket surface according to the one or more interface breaking projections.

13. The valve assembly of claim 1, wherein the recessed surface and the one or more interface breaking projections are configured to assist with biasing of the valve operator between an open position and a closed position according to conveyed pressurized fluid between the surface of the valve operator and the valve operator socket surface.

14. The valve assembly of claim 1, wherein the recessed surface and the one or more interface breaking projections are configured to abort one or more of a vacuum or adhesion based interface between the valve operator and the valve operator socket surface.

15. The valve assembly of claim 1 comprising a solenoid coil coupled with the valve body, the solenoid coil is configured to bias the valve operator toward at least one of open and closed positions.

16. The valve assembly of claim 1, comprising a biasing element coupled with the valve operator, the biasing element is configured to bias the valve operator toward a closed position.

17. The valve assembly of claim 1 comprising an agricultural product fluid reservoir in communication with the fluid inlet and a dispensing nozzle in communication with the fluid outlet.

18. The valve assembly of claim 1 comprising an agricultural product injectant fluid reservoir in communication with the fluid inlet and an injector port in communication with the fluid outlet, the injector is configured to inject agricultural product injectant into a carrier fluid passage.

19. The valve assembly of claim 18 comprising a dispensing nozzle in communication with the carrier fluid passage, and the dispensing nozzle is configured to dispense the carrier fluid with the injected agricultural product injectant therein.

20. The valve assembly of claim 19, wherein the dispensing nozzle is immediately adjacent to the fluid outlet of the valve body.

21. The valve assembly of claim 1, wherein the valve operator is a poppet valve operator.

22. A valve assembly comprising:
a valve body including a fluid inlet and a fluid outlet;
an operator cavity within the valve body, the valve body includes a valve operator socket surface;
a valve operator within the operator cavity, the valve operator slidably coupled with the valve body, the valve operator includes:
an operator surface,
a recessed surface, and
one or more interface breaking projections extending from the recessed surface; and
the valve operator is configured for movement between closed and open positions with respect to one or more of the fluid inlet and the fluid outlet:
in the open position the valve operator is biased away from each of the fluid inlet and the fluid outlet, and the one or more interface breaking projections space the recessed surface from the valve operator socket surface, and
in the closed position the valve operator is remote from the valve operator socket surface and the operator surface isolates the fluid inlet from the fluid outlet.

23. The valve assembly of claim 22, wherein the one or more interface breaking projections include corrugations extending from the recessed surface, and the recessed surface includes grooves between the corrugations.

24. The valve assembly of claim 22, wherein the one or more interface breaking projections include one or more posts extending from the recessed surface.

25. The valve assembly of claim 22, wherein the one or more interface breaking projections include an interface breaking surface distributed over a portion of the recessed surface.

26. The valve assembly of claim 22, wherein the recessed surface and the one or more interface breaking projections are configured to receive a pressurized conveyed fluid, the pressurized conveyed fluid between the recessed surface and the valve operator socket surface.

27. The valve assembly of claim 22, wherein the recessed surface and the one or more interface breaking projections are configured to assist with biasing of the valve operator from the open position to the closed position according to conveyed pressurized fluid between the recessed surface and the valve operator socket surface.

28. The valve assembly of claim 22, wherein the recessed surface and the one or more interface breaking projections are configured to abort one or more of a vacuum or adhesion based interface between the valve operator and valve operator socket surface.

29. The valve assembly of claim 22 comprising a solenoid coil coupled with the valve body, the solenoid coil is configured to bias the valve operator into at least one of the open and closed positions.

30. The valve assembly of claim 29, comprising a biasing element coupled with the valve operator, the biasing element is configured to bias the valve operator into the closed position.

31. The valve assembly of claim 22 comprising an agricultural product fluid reservoir in communication with the fluid inlet and a dispensing nozzle in communication with the fluid outlet.

32. The valve assembly of claim 22 comprising an agricultural product injectant fluid reservoir in communication with the fluid inlet and an injector in communication with the fluid outlet, the injector is configured to inject the agricultural product injectant into a carrier fluid passage.

33. The valve assembly of claim 32 comprising a dispensing nozzle in communication with the carrier fluid passage, and the dispensing nozzle is configured to dispense the carrier fluid and the injected agricultural product injectant therein.

34. The valve assembly of claim 33, wherein the dispensing nozzle is immediately adjacent to the fluid outlet of the valve body.

35. The valve assembly of claim 22, wherein the valve operator is a poppet valve operator.

36. The valve assembly of claim 22, wherein the one or more interface breaking projections include one or more of a post, ridge, boss, knurling or ring.

37. The valve assembly of claim 22, wherein the recessed surface includes one or more of a plane, scallops, channels or grooves.

38. The valve assembly of claim 22, wherein the recessed surface includes a recessed surface area greater than a projection surface area of the one or more interface breaking projections.

39. The valve assembly of claim 22, wherein the recessed surface includes a recessed surface area and the one or more interface breaking projections include a projection surface area, and a ratio of recessed surface area to projection surface area is between 9:1 to 1:4.

40. The valve assembly of claim 22, wherein the recessed surface includes a recessed surface area and the one or more interface breaking projections include a projection surface area, a ratio of recessed surface area to projection surface area is is between 9:1 to 1:2.

41. A method of operating a valve assembly comprising:
setting a valve operator in an open position, setting the valve operator in the open position includes:
engaging the valve operator with a valve operator socket surface of a valve body, and
spacing an end surface of the valve operator from the valve operator socket surface with one or more interface breaking projections extending from a recessed surface;
infiltrating a pressurized conveyed fluid across the recessed surface according to the spacing by the one or more interface breaking projections; and
moving the valve operator from the open position into a closed position, moving into the closed position includes:
moving the valve operator away from the valve operator socket surface, and
assisting movement of the valve operator away from the valve operator socket surface according to the infiltrated pressurized conveyed fluid.

42. The method of claim 41, wherein setting the valve operator in the open position includes delivering a current through a solenoid coil and setting the valve operator in the open position according to the current.

43. The method of claim 42, wherein moving the valve operator into the closed position includes arresting delivery of the current through the solenoid coil and moving the valve operator into the closed position according to a biasing element.

44. The method of claim 42, wherein moving the valve operator into the closed position includes reversing the direction of the current through the solenoid coil and moving the valve operator into the closed position according to the reversed direction of the current.

45. The method of claim 41, wherein infiltrating the pressurized conveyed fluid across the recessed surface includes aborting one or more of an adhesion or vacuum interface between the valve operator and the valve operator socket surface.

46. The method of claim 41, wherein setting the valve operator in the open position includes conveying the conveyed fluid from a fluid inlet to a fluid outlet.

47. The method of claim 46, wherein moving the valve operator from the open position into the closed position includes isolating the fluid inlet from the fluid outlet.
